(19) United States
(12) Patent Application Publication
(10) Pub. No.: US 2024/0008074 A1
(43) Pub. Date: Jan. 4, 2024

(54) METHODS FOR COMMUNICATION, DEVICE, AND COMPUTER READABLE MEDIA

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/036,037

(22) PCT Filed: Dec. 1, 2020
(86) PCT No.: PCT/CN2020/133161

§ 371 Date: May 9, 2023

(51) Int. Cl. H04W 74/08

(52) U.S. Cl. CPC H04W 74/0808

(57) ABSTRACT

Embodiments of the present disclosure provide a solution for sidelink resources allocation. In a method for communication, a first terminal device monitors a control channel from a second terminal device for sidelink control information. The sidelink control information indicates a frequency resource assignment and a time resource assignment to be used by the second terminal device. Then the first terminal device measures a power of a reference signal received on a channel associated with the sidelink control information, and determines availability of a first resource in a set of resources for the first terminal device at least based on the frequency resource assignment, the time resource assignment and the power. With the embodiments of the present disclosure, sidelink resource allocation can be performed for aperiodic traffic transmission.

### FIELD

Embodiments of the present disclosure generally relate to the field of communication, and in particular, to a solution for sidelink resources allocation.

### BACKGROUND

Certain communication systems enable vehicle to everything (V2X) and device to device (D2D) communications to be performed. V2X communications can be based on communication technologies such as sidelink communication technologies. For this, sidelink resource pools and sidelink channels can be established for vehicles participating in such communications.

In V2X communications, there are two modes of resource allocation. In a first mode (also referred to as NR V2X mode 1 or mode 1 hereinafter), a terminal device may perform V2X communications with another terminal device by using resources allocated by a network device. In the second mode (also referred to as NR V2X mode 2 or mode 2 hereinafter), a terminal device may perform V2X communications with another terminal device by using resources autonomously selected in a resource selection window by the terminal device. In mode 2, a terminal device may select resources in the resource selection window by performing sensing of sidelink channels, partial sensing of the sidelink channels, or random selection of the resources.

### SUMMARY

In general, example embodiments of the present disclosure provide a solution for sidelink resources allocation.

In a first aspect, there is provided a method for communication. The method comprises monitoring, at a first terminal device, a control channel from a second terminal device for sidelink control information, the sidelink control information indicating a frequency resource assignment and a time resource assignment of resources to be used for initial transmission and retransmission(s) of a same transport block (TB) by the second terminal device. The method also comprises measuring a power of a reference signal received on a channel associated with the sidelink control information. The method further comprises determining availability of a first resource in a set of resources for the first terminal device at least based on the frequency resource assignment, the time resource assignment and the power.

In a second aspect, there is provided a first terminal device. The first terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

It should be appreciated that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, where:

FIG. 1 is a schematic diagram of a communication environment in which some embodiments of the present disclosure can be implemented;

FIG. 2 illustrates a flow chart of a process of sidelink resources allocation in accordance with some embodiments of the present disclosure;

FIG. 3 illustrates a schematic diagram of an example of sidelink resource allocation in accordance with some embodiments of the present disclosure;

FIGS. 4A and 4B illustrates schematic diagrams of examples of sidelink resource allocation in accordance with some embodiments of the present disclosure;

FIGS. 5A and 5B illustrate schematic diagrams of examples of sidelink resource allocation in accordance with some embodiments of the present disclosure, respectively;

FIG. 6 illustrates a flowchart of a method for sidelink resources allocation in accordance with some embodiments of the present disclosure; and

FIG. 7 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It should be appreciated that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an evolved NodeB (eNodeB or eNB), a next generation NodeB (gNB), an infrastructure device for a V2X communication, a transmission/reception point (TRP), a remote radio unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, some embodiments will be described with reference to UEs as examples of terminal devices and the terms “terminal device” and “user equipment” (UE) may be used interchangeably in the context of the present disclosure.

In one embodiment, a terminal device may be connected with a first network device and the second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is an eNB and the second RAT device is a gNB.

Information related to different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As indicated, a terminal device may select resources in the resource selection window by performing sensing of sidelink channels, partial sensing of the sidelink channels, or random selection of the resources. In the case of sensing, the terminal device may select all the potential candidate resources in the resource selection window. Then, the terminal device may determine whether all the potential candidate resources are occupied by other terminal devices by performing sensing. In the case of partial sensing, the terminal device may select part of all the potential candidate resources in the resource selection window. In turn, the terminal device may determine whether the selected potential candidate resources are occupied by other terminal devices by performing partial sensing. The partial sensing is especially designed for power saving purpose. In the case of random selection, the terminal device will not determine whether the potential candidate resources are occupied by other terminal devices by performing sensing or partial sensing. Instead, the terminal device may consider all the potential candidate resources may be used as candidate resources for a sidelink transmission.

Whereas, for the case of partial sensing mentioned above, only periodic traffic transmission is defined and supported in LTE sidelink. Specifically, in LTE partial sensing, the periodic traffic transmission is as follows. In the first step, Y candidate single-subframe resources within a resource selection window are determined. Y can be defined to be equal to or greater than a minNumCandidateSF, where minNumCandidateSF is the minimum number of candidate subframes needs to be provided to higher layer of the terminal device for PSCCH/PSSCH transmission. In the second step, any subframe t_{y-k×P}^{SL} within a sensing window is monitored, where t_{y}^{SL} is a subframe included in the set Y and k×P is indicated by high layer parameter gapCandidateSensing. In the third step, associated resources within the resource selection window by SCI decoding and RSRP measurement are excluded from set Y. That is, the associated resources being excluded are actually reserved to be used by other terminal device for transmission and level of interference would be experienced by sensing UE is high for example.

By comparison, in new radio (NR), both periodic traffic transmission and aperiodic traffic transmission are defined, and meanwhile, partial sensing will also be supported for the purpose of power saving in NR.

However, LTE only supports periodic transmission and does not support aperiodic traffic transmission. Meanwhile, the solution for periodic transmission mentioned above is not applicable for aperiodic transmission. It is because, in the conventional solution for periodic transmission in LTE partial sensing as mentioned above, the arriving timing of periodic traffic is predictable, thus a terminal device is able to know which slots should be sensed before a packet arrives. That is, the terminal device knows where to perform sensing before a trigger in slot n (may also be referred to as a sensing result trigger, which is triggered by higher layer of the terminal device and request for resource selection), which is due to the periodicity of traffic transmission in LTE. Because of the predictability of the trigger in slot n, when the trigger comes, selection can be performed based on the sensing results which are result from sensing at a predetermined period prior to the trigger, through which the terminal device is able to know whether the resource is available to be used.

However, since the arriving time of aperiodic traffic is unpredictable, the terminal device is not able to know which slots should be sensed and which slots should be skipped before the packet's (i.e. the aperiodic traffic) arrives. As result, there is no sensing result for aperiodic traffic's transmission and the solution for partial sensing in LTE is not applicable for aperiodic traffic's transmission. Whereas, as mentioned above, partial sensing is a power-saving solution for traffic transmission. Thus, in order to save power and meanwhile provide a reliable and robust traffic transmission, a solution for aperiodic traffic transmission is needed for partial sensing.

In order to solve the above technical problems and potentially other technical problems in conventional solutions, embodiments of the present disclosure provide a solution for sidelink resources allocation. In some embodiments, the first terminal device monitors a control channel from the second terminal device for sidelink control information. The sidelink control information indicates a frequency resource assignment and a time resource assignment of resources to be used for same TB's initial transmission and retransmission(s) by the second terminal device. Further, the first terminal device measures a power of a reference signal received on a channel associated with the sidelink control information, and determines availability of a first resource in a set of resources for the first terminal device at least based on the frequency resource assignment, the time resource assignment and the power. With embodiments of the present disclosure, a feasible solution for sidelink resource allocation is provided for aperiodic traffic transmission. Further, since the embodiments of the present disclosure are designed for partial sensing, power-saving is able to be achieved. Moreover, resource reservation by other terminal device is considered when selecting resource for the terminal device (i.e. the first terminal device), thereby providing a reliable and robust resource selection scheme. Principles and implementations of the present disclosure will be described in detail below with reference to the figures.

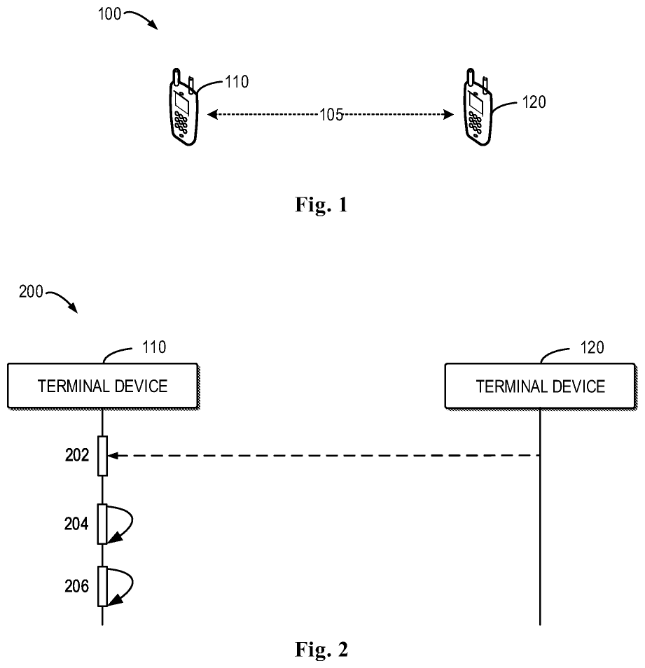

FIG. 1 is a schematic diagram of a communication environment 100 in which some embodiments of the present disclosure can be implemented. As shown in FIG. 1, the communication environment 100, which may also be referred to as a communication network 100, includes a first terminal device 110 and the second terminal device 120. In particular, the first terminal device 110 and the second terminal device 120 can also be referred to as the terminal device 110 and the terminal device 120. The first terminal device 110 may communicate with the second terminal device 120 via a device-to-device (D2D) channel 105, which may also be referred to as a sidelink channel 105. In such cases, a network device may be absent in the communication environment 100. For example, one or more of the first terminal device 110, the second terminal device 120 and other terminal devices (not shown) may be out of the coverage of the network device. That is, only sidelink communications exist between the first terminal device 110 and the second terminal device 120 as well as possibly other terminal devices not shown in FIG. 1.

In some embodiments, during a sidelink communication between the first terminal device 110 and the second terminal device 120 via the sidelink channel 135, the first terminal device 110 can perform a sidelink transmission to the second terminal device 120 using a set of transmission resources. As used herein, the term “sidelink transmission” generally refers to any transmission performed from one terminal device to another terminal device via a sidelink channel between them. The sidelink transmission may be used for transmitting any data or control information associated with sidelink communications, for example, sidelink data or sidelink control information or sidelink feedback information. As used herein, the term “sidelink channel” may generally refer to any channels for sidelink communications, for example, a physical sidelink shared channel (PSSCH), physical sidelink control channel (PSCCH), physical sidelink discovery channel (PSDCH), physical sidelink broadcast Channel (PSBCH), physical sidelink feedback channel (PSFCH), and other existing or future sidelink channels.

As used herein, the term “resource,” “transmission resource,” or “sidelink resource” may refer to any resource for performing a communication, for example, a sidelink communication between terminal devices, such as a resource in time domain (for example, a time slot), a resource in frequency domain (for example, a sub-channel), a resource in space domain, a resource in code domain, or any other resource enabling a communication, and the like. In the following, a resource in both frequency domain and time domain may be used as an example of a sidelink resource for describing some embodiments of the present disclosure. However, it should be appreciated that embodiments of the present disclosure are equally applicable to any other resources in any other domains.

Although the first terminal device 110 and the second terminal device 120 are described in the communication environment 100 of FIG. 1, embodiments of the present disclosure may be equally applicable to any other suitable communication devices in communication with one another. That is, embodiments of the present disclosure are not limited to the example scenario of FIG. 1. In this regard, it should be appreciated that although the first and second terminal devices 110 and 120 are schematically depicted as mobile phones in FIG. 1, it is understood that this depiction is only for the purpose of illustration, without suggesting any limitation. In other embodiments, the first and second terminal devices 110 and 120 may be any other wireless communication devices, for example, vehicle-mounted terminal devices.

In case the first and second terminal devices 110 and 120 are vehicle-mounted terminal devices, the communications relate to them may be referred to as V2X communications. More generally, although not shown in FIG. 1, a V2X communication related to the first and second terminal devices 110 and 120 may include a communication between the first or second terminal devices 110 or 120 and any other communication device, including but not limited to, an infrastructure device, another vehicle-mounted terminal device, a device of a pedestrian, a roadside unit, and the like. Furthermore, although not shown, all the communication links as shown in FIG. 1 may be via one or more relays.

It should be appreciated that the number of the terminal devices as shown in FIG. 1 is only for the purpose of illustration, without suggesting any limitations. The communication environment 100 may include any suitable number of terminal devices, any suitable number of network devices, and any suitable number of other communication devices adapted for implementing embodiments of the present disclosure. In addition, it should be appreciated that there may be various wireless communications as well as wireline communications (if needed) among all the communication devices.

The communications in the communication environment 100 may conform to any suitable standards including, but not limited to, global system for mobile communications (GSM), extended coverage global system for mobile Internet of things (EC-GSM-IoT), long term evolution (LTE), LTE-Evolution, LTE-Advanced (LTE-A), wideband code division multiple access (WCDMA), code division multiple access (CDMA), GSM EDGE radio access network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

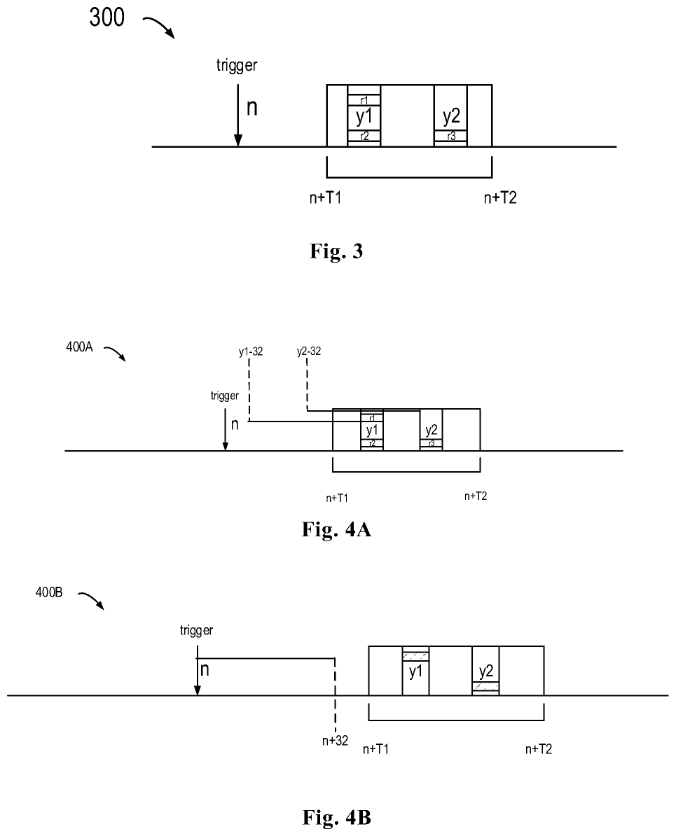

FIG. 2 illustrates a flow chart of a process of sidelink resources allocation in accordance with some embodiments of the present disclosure. FIG. 3 and FIGS. 4A-4B illustrate schematic diagrams of examples of sidelink resource allocation in accordance with some embodiments of the present disclosure. In the following part, an example sidelink resource allocation process will be illustrated with reference to FIGS. 2-4 according to some embodiments of the present disclosure. It should be appreciated that embodiments of the present disclosure are not limited to the example process shown in FIG. 2.

As shown in FIG. 2, terminal device 110 monitors 202 a control channel from terminal device 120 for sidelink control information. The sidelink control information indicates a frequency resource assignment and a time resource assignment to be used by the second terminal device.

Additionally, if it is determined that a sidelink transmission transmitted from the first terminal device is an aperiodic transmission, the terminal device 110 may monitor the control channel. In some embodiments, if it is determined that partial sensing is enabled for the terminal device 110, the terminal device 110 may monitor the control channel.

Additionally or alternatively, if it is determined that a trigger for resource selection is provided from a high layer to a physical layer of the terminal device 110, the terminal device 110 may monitor the control channel. Alternatively, the terminal device 110 monitors the control channel prior to determining that a trigger for resource allocation is provided from a high layer to a physical layer of the terminal device 110.

Additionally, the terminal device 110 monitors the control channel during a predetermined window.

Further, terminal device 110 measures 204 the power of a reference signal received on a channel associated with the sidelink control information. In one example, the power may be reference signal receiving power of demodulation reference (DM-RS).

Then, the terminal device 110 determines 206 the availability of the first resource in a set of resources for the terminal device 110 at least based on the frequency resource assignment, the time resource assignment and the power. With embodiments of the present disclosure, a feasible solution for sidelink resource allocation is provided for aperiodic traffic transmission. Further, since the embodiments of the present disclosure are designed for partial sensing, power-saving is able to be achieved. Moreover, resource reservation by other terminal device is considered when selecting resource for the terminal device (i.e. the terminal device 110), thereby providing a reliable and robust resource selection scheme.

In some embodiments, the sidelink control information may include information on the second resource to be used by the second terminal device. For example, the second resource is to be used by the second terminal device for initial transmission and retransmission(s) of a same TB In such embodiments, the terminal device 110 may further determines the second resource based on a resource on which the sidelink control information is received, the time resource assignment and the frequency resource assignment.

If it is determined that the first resource is non-overlapped with the second resource in time domain and the power is equal to or below a predetermined threshold value, the terminal device 110 may determine that the first resource is available for the terminal device 110. Alternatively, in some other embodiments, if it is determined that the first resource is non-overlapped with the second resource in frequency domain and the power is equal to or below a predetermined threshold value, the terminal device 110 may determine that the first resource is available for the terminal device 110.

On the other hand, if it is determined that the first resource is overlapped with the second resource in both time domain and frequency domain and the power exceeds a predetermined threshold value, the terminal device 110 may determine that the first resource is unavailable for the first terminal device.

In some embodiments, the terminal device 110 may also determine the availability of the first resource based on the frequency resource assignment, the time resource assignment, the power and a priority of the transmission of the second terminal device in the sidelink control information. For example, if it is determined that the first resource is overlapped with the second resource in both time domain and frequency domain and the power exceeds a predetermined threshold value, and also a priority of the transmission of the second terminal device in the sidelink control information is higher than the priority of the transmission of the first terminal device, the terminal device 110 may determine that the first resource is unavailable for the first terminal device.

In the case that the first resource is unavailable, the terminal device 110 may provide information on the unavailability from the physical layer to the high layer.

Additionally, in some embodiments, if a trigger for resource selection is provided from a high layer to a physical layer of the terminal device 110, at the terminal device 110, candidate resources may be provided from the physical layer to the high layer. After that, the terminal device 110 may provide, from the high layer to the physical layer, the set of resources selected from the candidate resources.

The staring time point of the predetermined window may be preset in a variety of ways. In some embodiments, the starting time point of the predetermined window may be a trigger time point at which a trigger for resource selection is provided from a higher layer to a physical layer of the first terminal device. Alternatively, the starting time point of the predetermined window may be the first time point that is a first predetermined number of time slots earlier than a starting time point of the set of resources. In one example, the starting time point of the set of resources may be the starting time point of the first resource in the set of resources. For example, as shown in FIG. 3, if the set of resources include r1 , r2 and r3, the staring time point of the set of resources is r1 (or r2 in this example) which is the first resource in the set of resources in time domain. In such embodiments, the first time point is later than the trigger time point. That is, the trigger for resource selection happens at time point n, r1—the first predetermined number of time slots is later than the time point n. For example, the first predetermined number of time slots may be 32 time slots. Accordingly, the starting time point of the predetermined window is r1−32 time slots as shown in FIG. 4A. In such embodiments, the time length between the starting time point of the candidate resources and the trigger time point may be equal to or exceed the time length of the second predetermined number of time slots. For example, when the second predetermined number of time slots is 32, the time length between y1 and the trigger n may be equal to or exceed 32 time slots, that is, y1>=n+32 time slots. In some other embodiments, the first and the second predetermined number may also be in the unit of symbol and subframe, and the like. The scope of the present disclosure is not limited in this regard.

As a further alternative, the starting time point of the predetermined window may be the second time point that is the second predetermined number of time slots earlier than a starting time point of candidate resources, which are provided from the physical layer to the higher layer in response to the trigger. In some implementations, for example, as shown in FIG. 3, if the candidate resources include y1 and y2, the staring time point of the candidate resources is y1. For example, the second predetermined number of time slots may be 32. Accordingly, the starting time point of the predetermined window may be y1−32 time slots as shown in FIG. 4A. In such embodiments, the second time point is the second predetermined number of time slots earlier than y1. Further, in such embodiments, the time length between the starting time point of the candidate resources and the trigger time point may be equal to or exceed the time length of the second predetermined number of time slots. For example, the second predetermined number of time slots may be 32 time slots. Accordingly, the time length between y1 and the trigger n may be equal to or exceed 32 time slots, that is, y1>=n+32 time slots.

As a still further alternative, a minimum offset may be preset between a resource selection window from the trigger time point. In one example, as shown in FIG. 4B, the terminal device 110 determines the start of resource selection window as n+T1 such that n+T1>=n+32 (or T1>32, T1: offset of selection window to n).

The ending time point for the predetermined window may be set in a variety of ways. For example, the ending time point may be an ending time point of the set of resources. In such example, as shown in FIG. 3, the ending time point of the set of resources is r3, when the set of resources include r1, r2 and r3, where r3 is the last resource in the set of resources in time domain. Alternatively, the ending time point for the predetermined window may be the ending time point of candidate resources, where the candidate resources is provided from a physical layer to a higher layer of the first terminal device in response to a trigger for resource selection. In such example, as shown in FIG. 3, the ending time point of the candidate resources is y2 when the candidate resources include y1 and y2.

Alternatively, in some embodiments, the ending time point for the predetermined window may be a fourth time point that is a first time period earlier than the ending time point of the set of resources. In such embodiment, for example, the ending time point may be r3−t_offset1 time slots. Alternatively, in some other embodiments, the ending time point for the predetermined window may be a fifth time point that is the second time period earlier than the ending time point of candidate resources. In such embodiment, for example, the ending time point may be y2−t_offset2 time slots.

In the following, some more detailed embodiments will be provided with reference to FIG. 3 and FIGS. 4A-4B. FIG. 3 illustrates a schematic diagram of an example of a sidelink resource allocation in accordance with some embodiments of the present disclosure. FIGS. 4A and 4B illustrate schematic diagrams of examples of sidelink resource allocation in accordance with some embodiments of the present disclosure.

In some embodiments, the physical layer of a terminal device 110 may receive a trigger for resource selection at a slot n (as shown in FIG. 3) from a higher layer (e.g., a medium access control (MAC) layer) of the terminal device 110. For example, the higher layer of the terminal device 110 may have traffic to be transmitted.

In some embodiments, after receiving the trigger for resource selection in the slot n, without any resource exclusion procedure, the terminal device 110 may determine if the traffic to be transmitted is periodic traffic or aperiodic traffic. If it is determined that the traffic to be transmitted is periodic, conventional solution for periodic transmission may be used in sidelink.

In such example embodiments, when partial sensing is configured, the terminal device 110 may determine whether the traffic to be transmitted is periodic using the following parameters provided from the higher layer. In one example, the terminal device 110 may determine whether the traffic is periodic transmission using the higher layer parameters sl-ResourceReservePeriodList and sl-MultiReserveResource. The higher layer parameter sl-ResourceReservePeriodList is a parameter used to indicate set of possible resource reservation period allowed in the resource pool in the unit of ms. The higher layer parameter sl-MultiReserveResource is a parameter used to indicates if it is allowed to reserve a sidelink resource for an initial transmission of a TB by an SCI associated with a different TB, based on sensing and resource selection procedure. Accordingly, when the higher layer parameters sl-ResourceReservePeriodList is valid (e.g., non-zero value) and sl-MultiReserveResource is configured as enable, the terminal device 110 may determine that the traffic to be transmitted is periodic traffic. When the traffic to be transmitted is periodic traffic, the terminal device 110 may determine that partial sensing occasions should be performed. i.e., RRC parameter gapCandidateSensing is applicable only for periodic traffics.

For example, according to the partial sensing occasions, if a slot t_y is included in the set of candidate sensing slots determined by the terminal device 110 in the selection window, the terminal device 110 shall monitor any slots t_y−k*P_step if k-th bit of the high layer parameter gapCandidateSensing is set to 1, where P_step is preconfigured as the time gap between each bit, e.g., given by Table 14.1.1-1 in TS 36.213 or 8.1.7 in TS 38.214. Further, the RRC parameter gapCandidateSensing indicates which slots should be sensed when a certain slot is considered as a candidate resource.

In some example embodiments, if it is determined that the traffic to be transmitted is aperiodic, the process will proceed to the next step. In one example, if partial sensing is configured, when the higher layer parameter sl-ResourceReservePeriodList is invalid (e.g., zero value) or the higher layer parameter sl-MultiReserveResource is not configured as enable, the terminal device 110 may determine that the traffic is aperiodic traffic. In such case, the process will proceed to the next step.

In some embodiments, then, the physical layer of the terminal device 110 may determine candidate resources (e.g., y1 and y2) within a resource selection window [n+T1, n+T2] (as shown in FIG. 3).

In some embodiments, after determining the candidate resources, the physical layer of the terminal device 110 may then provide the determined candidate resources (e.g., y1 and y2) to the higher layer (e.g., the MAC layer) without any resource exclusion.

In some embodiments, the physical layer of the terminal device 110 may also reports/provides all the slots resources within resource selection window (not shown). It should be appreciated that the physical layer of the terminal device 110 may also provide part or all of the slots resources within resource selection window to higher layer of the terminal device 110 for resource selection and the scope of the present disclosure is not limited in this regard.

In some embodiments, the higher layer of the terminal device 110 (e.g., the MAC layer) may then select a set of resources from the candidate resources (e.g., y1, y2) provided by the physical layer. In one example, the higher layer of the terminal device 110 may randomly select the set of resources from the candidate resource. However, it should be appreciated that the higher layer of the terminal device 110 may select the set of resources using ways other than random selection, and the scope of the present disclosure is not limited in this regard. After that, the higher layer of the terminal device 110 may provide the set of resources to the physical layer thereof.

In some examples, as a result of random selection, the MAC layer of the terminal device 110 may randomly select a set of resources r1 , r2, and r3 from the candidate resources, as shown in FIG. 3. Then the selected set of resources may be provided by the MAC layer to the physical layer for monitoring and rechecking.

In some embodiments, the physical layer of the terminal device 110 monitors a control channel from other terminal devices (e.g., a terminal device 120) for sidelink control information. In one example, the other terminal devices (e.g., the terminal device 120) may transmit sidelink control information via the control channel to the terminal device 110 or other devices. That is, the other terminal devices, for example, the terminal device 120, transmits SCI on PSCCH for resource reservation. In some embodiments, the terminal device 110 decodes SCI format 1-A or SCI in PSCCH received from other terminal devices. The sidelink control information includes a frequency resource assignment and a time resource assignment which indicates resources to be used by the terminal device 120. As a result, the terminal device 120 may know from the frequency resource assignment and the time resource assignment of the resource to be used by the terminal device 120. In one example, the resource to be used by the terminal device 120 is for initial transmission and retransmission(s) of a same TB and may be determined based on a resource on which the sidelink control information is received, the time resource assignment and the frequency resource assignment.

Frequency resource assignment is m bits when the value of the higher layer parameter sl-MaxNumPerReserve is configured to 2, otherwise the frequency resource assignment is n bits when the value of the higher layer parameter sl-MaxNumPerReserve is configured to 3, as defined in clause 8.1.2.2 of [6, TS 38.214]. m and n are as defined in formulas (1) and (2) below, respectively:

$$m = ⌈ {log}_{2} ( \frac{{N}_{subChannel}^{S L} ( {N}_{subChannel}^{S L} + 1 )}{2} ) ⌉ \qquad ( 1 )$$

$$n = ⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉ \qquad ( 2 )$$

Time resource assignment is 5 bits when the value of the higher layer parameter sl-MaxNumPerReserve is configured to 2; otherwise is 9 bits when the value of the higher layer parameter sl-MaxNumPerReserve is configured to 3, as defined in clause 8.1.2.1 of [6, TS 38.214].

In some embodiments, the terminal device 110 measures the power of a reference signal received on a channel associated with the sidelink control information. In one example, the power may be reference signal receiving power (RSRP) of associated DM-RS. In such embodiments, for example, in sidelink resource allocation mode 2, the terminal device 110 may measure the RSRP for resource selection with PSSCH-RSRP over the DM-RS resource elements for the PSSCH according to the received SCI format 1-A if higher layer parameter sl-RS-ForSensing is set to “pssch”. For another example, the terminal device 110 may measure RSRP for resource selection with PSSCH-RSRP over the DM-RS resource elements for the PSCCH carrying to the received SCI format 1-A if higher layer parameter sl-RS-ForSensing is set to “pscch”.

In some embodiments, the terminal device 110 may then determine the availability of a resource in the set of resource for the terminal device 110 at least based on the frequency resource assignment, the time resource assignment and the power. In some examples, the sidelink control information includes information on a resource to be used by the terminal device 120 for a same TB. In some examples, if the resource in the set of resources is non-overlapped with the second resource in time domain and the power is equal or below a predetermined threshold value, the terminal device 110 may determine that the resource in the set of the resources is available for the terminal device 110. In some other examples, if the resource in the set of resources is non-overlapped with the second resource in frequency domain and the power is equal or below a predetermined threshold value, the terminal device 110 may determine that the resource in the set of the resources is available for the terminal device 110.

In some other examples, if a resource in the set of resources is overlapped with the second resource in both time domain and frequency domain and the power exceeds a predetermined threshold value, the terminal device 110 may determine that the resource in the set of the resources is not available for the terminal device 110, the terminal device 110 may determines that the resource is not available for the first terminal device. In some example embodiments, the terminal device 110 may determine the availability for each resource in the set of the resources.

In some examples, the resource to be used by the terminal device 120 may be determined based on a resource on which the sidelink control information is received, the time resource assignment and the frequency resource assignment.

In some embodiments, the terminal device 110 may determine the availability of the first resource in the set of resources based on the sidelink control information, the power and the priority of the transmission of the terminal device 120 in the sidelink control information. In one example, if a resource in the set of resources is overlapped with the second resource in both time domain and frequency domain and the power exceeds a predetermined threshold value and the priority of the transmission of the terminal device 120 in the sidelink control information is higher than that of the terminal device 110, the terminal device 110 may determine that the resource in the set of the resources is not available for the terminal device 110.

In some embodiment, if the physical layer of the terminal device 110 determines that a resource in the set of the resource is not available for the terminal device 110, and such unavailability may be reported to higher layer of the terminal device 110. In some examples, after receiving such report from the physical layer, the higher layer of the terminal device 110 may perform resource reselection, so as to select another resource and provide it to the physical layer. In some other examples, when such report is received, the higher layer of the terminal device 110 may perform resource reselection by selecting another set of resources and provide them to the physical layer for rechecking. Alternatively, the higher layer may do nothing. It should be appreciated that the higher layer may perform in many ways which is not limited to those mentioned above, and the scope of the present disclosure is not limited in this regard.

In some example embodiments, the physical layer informs MAC layer of the terminal device 110 about the conflicted resource before the resource timing, such that the conflicted resource will not be used by the terminal device 110. Otherwise, once the set of resources are selected, terminal device 110 may perform transmission with the set of resources.

In some embodiments, the terminal device 110 may perform monitoring and measuring the associated RSRP during a predetermined window having a starting time point and an ending time point. That is, during this predetermined window, the terminal device 110 may perform rechecking so as to determine the resource in the set of resource selected by the higher layer of the terminal device 110 is able to be used for transmission, such that the resource collision can be avoided. In the following part, some example embodiments will be provided with respect to the predetermined window.

FIGS. 4A and 4B illustrates examples of a predetermined window in accordance with some embodiments of the present disclosure. It should be appreciated that though some example embodiments are provided for the window, the starting time and ending point of the window may also be at other time points, and the scope of the present disclosure is not limited in this regard.

As shown in FIG. 4A, a trigger for resource selection for a terminal device 110 may occur at time point n. In some embodiments, the terminal device 110 may starts monitoring the control channel at the trigger time point n.

As mentioned above, the physical layer of the terminal device 110 may selects candidate resources (e.g., y1 and y2) and provided them to higher layer of the terminal device 110 and the higher layer may select a set of resources (e.g., r1, r2 and r3) from the candidate resources. Accordingly, in some other embodiments, the terminal device 110 may begin to monitor the control channel for sidelink control information at a predetermined number of time slots earlier than y1, where y1 is the first resource in the candidate resources. In such embodiments, one restriction is that the time length between a starting time point of the candidate resources e.g., y1 and the trigger time point should be equal to or exceed the predetermined number of time slots. That is, the time point that is a predetermined number of time slots earlier than y1 should be later than the trigger time point n. More discussion on the restrictions will be discussed further in the following part. ‘

With the above solution, the recheck/monitoring performed by the terminal device 110 may happen later than the trigger time point n, thereby saving power for the terminal device 110.

In one example, considering that the resource reservation performed by the other terminal devices (e.g., the terminal device 120) happens within 32 time slots before y1, the terminal device 110 may begin to monitor the control channel for sidelink control information 32 time slots earlier than y1, that is, the starting time point is y1−32 time slots as shown in FIG. 4A. As such, the terminal device 110 is able to have enough time to recheck/monitor so as to avoid resource collision.

In some other embodiments, the terminal device 110 may begin to monitor the control channel at a predetermined number of time slots earlier than r1, where r1 is the first resource in the set of resources selected by higher layer. As such, if the higher layer of the terminal device 110 selects r1 which is in y2 (not shown), that is, no resource in y1 (which is earlier than y2 as shown in FIG. 4A) is selected, the terminal device 110 does not need to perform recheck/monitoring at y1, thereby reducing the size of the predetermined window, thus further saving power for the terminal device 110.

In one example, the terminal device 110 may begin to monitor the control channel for sidelink control information 32 time slots earlier than r1, that is, the starting time point is at r1−32 time slots.

In some example embodiments, when the starting time point is at a predetermined number of time slots earlier than y1 or r1, there are some additional restrictions needs to follow. In one example, the terminal device 110 may determine the candidate resource slots such that the time length between the starting time point of the candidate resources (e.g., y1) and the trigger time point (e.g., n) equals to or exceeds the time length of the predetermined number of time slots (e.g., 32 time slots). As such, it is ensured that the beginning of predetermined window starts after the trigger time point n.

Alternatively, in some example embodiments, when the starting time point is at a predetermined number of time slots earlier than y1 or r1, the terminal device 110 may determine the beginning of resource selection window n+T1 such that n+T1>=n+32 (or T1>32, T1: offset of selection window to n), as shown in FIG. 4B. As such, it is ensured that the beginning of predetermined window starts after the trigger time point n.

In some embodiments, the predetermined window for rechecking may end at y2 or r3, where y2 is the last resource in the candidate resources and r3 is the last resource in the set of resource. Alternatively, the predetermined window for rechecking may end at an offset before r3 or y2, considering that the terminal device 110 needs some processing time to process the monitored SCI information and report possible resource overlap to higher layer. As a result, the predetermined window may end earlier, thereby saving power for the terminal device 110.

In some embodiments, in order to provide a solution for aperiodic traffic transmission for partial sensing, embodiments of the present disclosure provide another solution for sidelink resources allocation. In this solution, the terminal device 110 reuses sensing results for periodic transmission. That is, the terminal device 110 may monitor occasions for periodic transmission to deliver sensing results for aperiodic transmission.

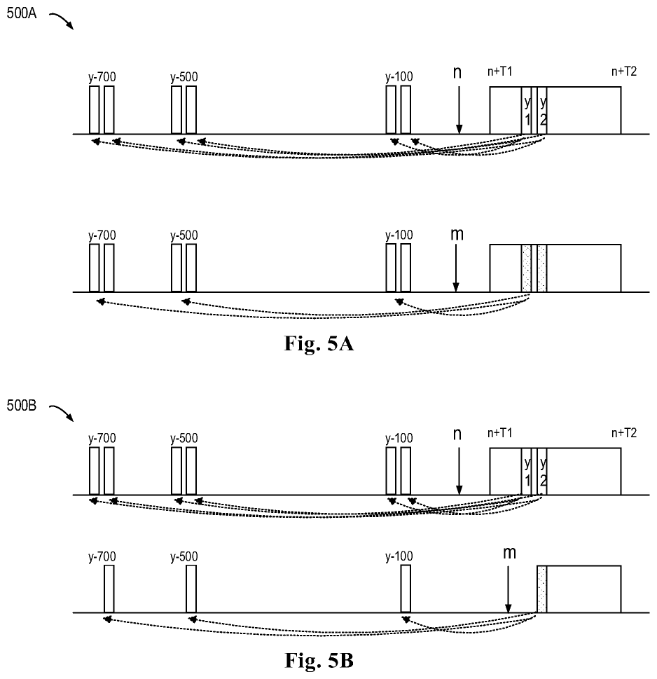

FIGS. 5A and 5B illustrate schematic diagrams of examples of sidelink resource allocation in accordance with some embodiments of the present disclosure, respectively. In some embodiments, as shown in FIG. 5A, if partial sensing is configured and an aperiodic traffic transmission's trigger for resource selection is m, and if resource selection window associated with the trigger in slot m includes at least one of the candidate slot resources of a periodic transmission's sensing result report trigger in slot n (e.g., y1 and y2), the terminal device 110 may determine associated candidate slot resources include at least the same set or a subset of the candidate slot resources determined for trigger in slot n. In one example, the resource selection window associated with the trigger in slot m includes at least one of the candidate slot resources (e.g., y1 or y2). As such, y1 and/or y2 can be determined as candidate resource aperiodic transmission.

In such embodiments, in one example, the trigger in slot n may be the one after or before this aperiodic trigger in slot m. In another example, the offset between triggers m and n may be less than a preconfigured threshold.

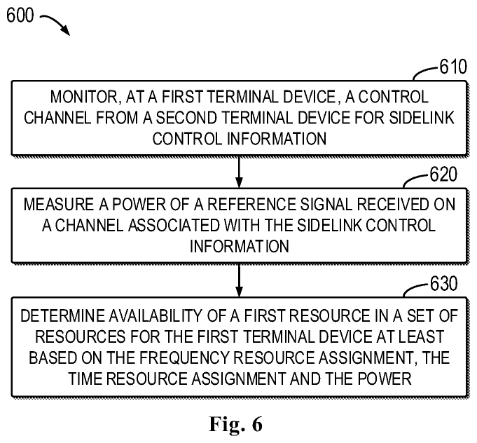

In some embodiments, as shown in FIG. 5A, both y1 and y2 may be determined at the first terminal device for aperiodic transmission. In some other embodiments, as shown in FIG. 5B, since only y2 is included in the candidate resources associated with the trigger in slot m, y2 may be determined for aperiodic transmission. In such embodiments, for example, the first half of y2 may be used for periodic transmission and the second half of y2 may be used for aperiodic transmission. The method of how y2 (or y1 and y2 in FIG. 6A) can be shared between the periodic transmission and the aperiodic transmission may vary, and the scope of the present disclosure is not limited in this regard.

In some embodiments, the terminal device 110 may exclude occupied resources within the candidate slot resource and reports the remaining resource along with other candidate slot resource, if any, to higher layer.

In some embodiments, a SCI can reserve one or two or three resources within 32 slots for aperiodic transmissions. Such resource reservation mechanism should be considered for the enhancement of partial sensing. However, the slots within the range [t_y0\hat{ }SL−32, n−T_(proc,0)\hat{ }SL) or [t_y0\hat{ }SL−31, n−T_(proc,0)\hat{ }SL) should be monitored in order to avoid the collision with aperiodic transmissions from other terminal devices, where t_y0\hat{ }SL is the first slot of the determined Y candidate slot resources for partial sensing and T_(proc,0)\hat{ }SL is a preset processing time of the sensing UE In order to solve the issues of aperiodic reservations from other terminal devices, the terminal device 110 may start monitoring the control channel (e.g., the PSCCH) and measure associated RSRP during a window prior to receiving trigger in slot n from higher layer.

In some embodiments, the terminal device 110 decodes SCI format 1-A or SCI in PSCCH received from other terminal devices. A frequency resource assignment and a time resource assignment to be used by the terminal device 120 are included in the sidelink control information. As a result, the terminal device 120 may know from the frequency resource assignment and the time resource assignment the resource to be used by the terminal device 120. For example, the resource is to be used for a same TB. As such, the physical layer of the terminal device 110 is able to exclude the occupied resources within the candidate slot resource and reports the remaining resources to higher layer.

In some embodiments, the window for such monitoring may start from a predetermined number of time slots earlier than a starting time point of the candidate resources, where the starting time is earlier than the trigger time point n. The predetermined number of time slots may be 32 time slots, as such, the terminal device 110 is able to have enough time to monitor the control channel for SCI for resource reservation of aperiodic transmission from other terminal devices, thereby avoiding resource collision. In some embodiments, the ending time point of the window for such monitoring may end at n−T_(proc,0)\hat{ }SL where T_(proc,0)\hat{ }SL is a preset processing time.

FIG. 6 illustrates a flowchart of another example method 600 in accordance with some embodiments of the present disclosure. In some embodiments, the method 600 can be implemented at a terminal device, such as the first terminal device 110 as shown in FIG. 1. Additionally or alternatively, the method 600 can also be implemented at the second terminal device 120 or other terminal devices not shown in FIG. 1. For the purpose of discussion, the method 1100 will be described with reference to FIG. 1 as performed by the terminal device 110 without loss of generality.

At block 610, the terminal device 110 monitors a control channel from a second terminal device for sidelink control information. The sidelink control information indicates a frequency resource assignment and a time resource assignment to be used by the second terminal device. At block 620, the first terminal device 110 measures a power of a reference signal received on a channel associated with the sidelink control information. At block 630, the first terminal device 110 determines availability of a first resource in a set of resources for the first terminal device at least based on the frequency resource assignment, the time resource assignment and the power.

In some embodiments, the sidelink control information comprises information on a second resource to be used by the second terminal device. And the method 600 further comprises that the terminal device 110 determines the second resource based on a resource on which the sidelink control information is received, the time resource assignment and the frequency resource assignment.

In some embodiments, the availability of the first resource is determined in the following way. In accordance with a determination that the first resource is non-overlapped with the second resource in time domain and the power is equal to or below a predetermined threshold value, the terminal device 110 determines that the first resource is available for the first terminal device. Alternatively, in accordance with a determination that the first resource is non-overlapped with the second resource in frequency domain and the power is equal to or below a predetermined threshold value, the terminal device 110 determines that the first resource is available for the first terminal device.

In some embodiments, the availability of the first resource is determined by using the following method. In accordance with a determination that the first resource is overlapped with the second resource in both time domain and frequency domain and the power exceeds a predetermined threshold value, the terminal device 110 determines that the first resource is unavailable for the first terminal device.

In some embodiments, the power is reference signal receiving power of DM-RS.

In some embodiments, the availability of the first resource is determined by determining the availability of the first resource based on the frequency resource assignment, the time resource assignment, the power and a priority of the transmission of the second terminal device in the sidelink control information. For example, if it is determined that the first resource is overlapped with the second resource in both time domain and frequency domain and the power exceeds a predetermined threshold value, and also a priority of the transmission of the second terminal device in the sidelink control information is higher than the priority of the transmission of the first terminal device, the terminal device 110 may determine that the first resource is unavailable for the terminal device 110.

In some embodiments, the method 600 further comprises that in response to a trigger for resource selection provided from a high layer to a physical layer of the first terminal device, candidate resources from the physical layer is provided to the high layer; and the set of resources selected from the candidate resources is provided from the high layer to the physical layer.

In some embodiments, the method 600 further comprises that in accordance with a determination that the first resource is unavailable, information on the unavailability from the physical layer is provided to the high layer.

In some embodiments, the terminal device 110 monitors the control channel in the following way. In accordance with a determination that a sidelink transmission transmitted from the first terminal device is an aperiodic transmission, the control channel is monitored.

In some embodiments, monitoring the control channel comprises that in accordance with a determination that partial sensing is enabled for the first terminal device, the control channel is monitored.

In some embodiments, monitoring the control channel comprises that in accordance with a determination that a trigger for resource selection is provided from a high layer to a physical layer of the first terminal device, the control channel is monitored.

In some embodiments, monitoring the control channel comprises the following: the control channel is monitored prior to a trigger for resource allocation is provided from a high layer to a physical layer of the first terminal device.

In some embodiments, the control channel is monitored during a predetermined window.

In some embodiments, a starting time point of the predetermined window is selected from at least one of: a trigger time point at which a trigger for resource selection is provided from a higher layer to a physical layer of the first terminal device, a first time point that is a first predetermined number of time slots earlier than a starting time point of the set of resources, the first time point being later than the trigger time point, a second time point that is a second predetermined number of time slots earlier than a starting time point of candidate resources, the candidate resources being provided from the physical layer to the higher layer in response to the trigger, or a third time point that is a third predetermined number of time slots earlier than the trigger time point.

In some embodiments, a time length between a starting time point of the candidate resources and the trigger time point equals to or exceeds a time length of the second predetermined number of time slots.

In some embodiments, a minimum offset is preset between a resource selection window from the trigger time point. In one example, as shown in FIG. 4B, the terminal device 110 determines the start of resource selection window n+T1 such that n+T1>=n+32 (or T1>32, T1: offset of selection window to n).

In some embodiments, an ending time point for the predetermined window is selected from at least one of: an ending time point of the set of resources, an ending time point of candidate resources, the candidate resources being provided from a physical layer to a higher layer of the first terminal device in response to a trigger for resource selection, a fourth time point that is a first time period earlier than the ending time point of the set of resources, a fifth time point that is a second time period earlier than the ending time point of candidate resources, or a sixth time point that is a third time period earlier than a trigger time point at which a trigger for resource selection is provided from a higher layer to a physical layer of the first terminal device.

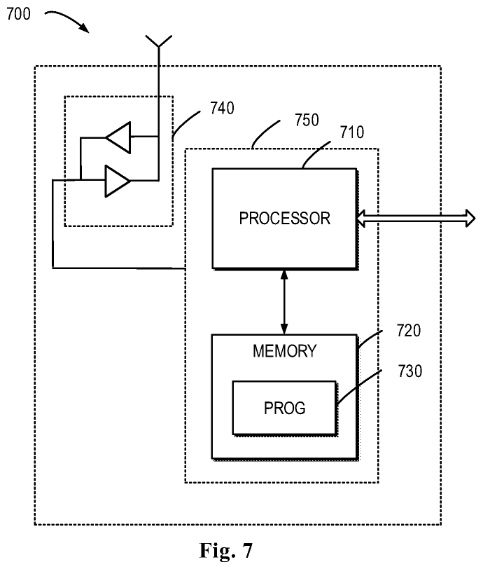

FIG. 7 is a simplified block diagram of a device 700 that is suitable for implementing some embodiments of the present disclosure. The device 700 can be considered as a further example embodiment of the first terminal device 110, the second terminal device 120 as shown in FIG. 1. Accordingly, the device 700 can be implemented at or as at least a part of the first terminal device 110, the second terminal device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 720 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a mobility management entity (MME)/serving gateway (S-GW) and the gNB or eNB, Un interface for communication between the gNB or eNB and a relay node (RN), or Uu interface for communication between the gNB or eNB and a terminal device.

The program 730 is assumed to include program instructions that, when executed by the associated processor 710, enable the device 700 to operate in accordance with the embodiments of the present disclosure, as discussed herein with reference to FIG. 2. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIG. 2. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it should be appreciated that the present disclosure defined in the appended claims is not necessarily limited to the specific features or acts described above. Rather, the specific features and acts described above are disclosed as example forms of implementing the claims.

1-19. (canceled)

20. A method performed by a terminal device, comprising:
determining candidate slot resources including first candidate slot resources corresponding to periodic transmission's sensing results within a resource selection window for resource selection triggered by an aperiodic transmission; and
performing partial sensing based on the determined candidate slot resources.

21. The method of claim 20, further comprising: determining the aperiodic transmission occurs based on a higher layer parameter being equal to 0.

22. A terminal device comprising a processor configured to cause the terminal device to:
determine candidate slot resources including first candidate slot resources corresponding to periodic transmission's sensing results within a resource selection window for resource selection triggered by an aperiodic transmission; and
perform partial sensing based on the determined candidate slot resources.

23. The terminal device of claim 22, wherein the processor is further configured to:
determine the aperiodic transmission occurs based on a higher layer parameter being equal to 0.
